(19) United States
(12) Patent Application Publication
(10) Pub. No.: US 2002/0187754 A1
(43) Pub. Date: Dec. 12, 2002

(54) Modulator for high data rate wireless communication

(76) Inventors: Richard Chedester, Whately, MA (US); Randall B. Olsen, Carlsbad, CA (US); Vladimir Kolinko, San Diego, CA (US); John Lovberg, San Diego, CA (US); Kenneth Y. Tang, Alpine, CA (US)

Correspondence Address: Ross Patent Law Office, P.O. Box 2138, Del Mar, CA, 92014, US

(21) Appl. No.: 10/127,886

(22) Filed: Apr. 23, 2002

Related U.S. Application Data
(63) Continuation-in-part of application No. 09/847,629, filed on May 2, 2001.

(51) Int. Cl. H04B 1/38

(52) U.S. Cl. 455/73

(57) ABSTRACT

A modulator for high data rate communication at frequencies greater than 50 GHz and at data rates of about 1.25 Gbps or greater. The modulator includes a resonant LC circuit including a diode which is back-biased for “off” (i.e., no transmit) and forward biased for “on” (or transmit). In preferred embodiments the modulator is a part of high performance transceivers for wireless, millimeter wave communications links. A preferred embodiment provides a communication link of more than eight miles which operates within the 71 to 76 GHz portion of the millimeter spectrum and provides data transmission rates of 1.25 Gbps with bit error rates of less than 10⁻¹⁰. A first transceiver transmits at a first bandwidth and receives at a second bandwidth both within the above spectral range. A second transceiver transmits at the second bandwidth and receives at the first bandwidth. The transceivers are equipped with antennas providing beam divergence small enough to ensure efficient spatial and directional partitioning of the data channels so that an almost unlimited number of transceivers will be able to simultaneously use the same spectrum. In a preferred embodiment the first and second spectral ranges are 71.8+/−0.63 GHz and 73.8+/−0.63 GHz and the half power beam width is about 0.2 degrees or less. Preferably, a backup transceiver set is provided which would take over the link in the event of very bad weather conditions.

The present invention relates to communication and specifically to modulators for high data rate communication. This application is a continuation in part application of U.S. patent application Ser. No. 09/847,629 filed May 2, 2001, which is incorporated by reference herein.

### BACKGROUND OF THE INVENTION

### Wireless Communication

### Point-to-Point and Point-to-Multi-Point

Wireless communications links, using portions of the electromagnetic spectrum, are well known. Most such wireless communication at least in terms of data transmitted is one way, point to multi-point, which includes commercial radio and television. However there are many examples of point-to-point wireless communication. Mobile telephone systems that have recently become very popular are examples of low-data-rate, point-to-point communication. Microwave transmitters on telephone system trunk lines are another example of prior art, point-to-point wireless communication at much higher data rates. The prior art includes a few examples of point-to-point laser communication at infrared and visible wavelengths.

### Need for High Data Rate Information Transmission

The need for faster information transmission is growing rapidly. Today and into the foreseeable future, transmission of information is and will be digital with volume measured in bits per second. To transmit a typical telephone conversation digitally utilizes about 5,000 bits per second (5 Kbits per second). Typical personal computer modems connected to the Internet operate at, for example, 56 Kbits per second. Music can be transmitted point to point in real time with good quality using mp3 technology at digital data rates of 64 Kbits per second. Video can be transmitted in real time at data rates of about 5 million bits per second (5 Mbits per second). Broadcast quality video is typically at 45 or 90 Mbps. Companies (such as telephone and cable companies) providing point-to-point communication services build trunk lines to serve as parts of communication links for their point-to-point customers. These trunk lines typically carry hundreds or thousands of messages simultaneously using multiplexing techniques. Thus, high volume trunk lines must be able to transmit in the gigabit (billion bits, Gbits, per second) range. Most modern trunk lines utilize fiber optic lines. A typical fiber optic line can carry about 2 to 10 Gbits per second and many separate fibers can be included in a trunk line so that fiber optic trunk lines can be designed and constructed to carry any volume of information desired virtually without limit. However, the construction of fiber optic trunk lines is expensive (sometimes very expensive) and the design and the construction of these lines can often take many months especially if the route is over private property or produces environmental controversy. Often the expected revenue from the potential users of a particular trunk line under consideration does not justify the cost of the fiber optic trunk line. Digital microwave communication has been available since the mid-1970's. Service in the 18-23 GHz radio spectrum is called “short-haul microwave” providing point-to-point service operating between 2 and 7 miles and supporting between four to eight T1 links (each at 1.544 Mbps). Recently, microwave systems operation in the 11 to 38 GHz band have reportedly been designed to transmit at rates up to 155 Mbps (which is a standard transmit frequency known as “OC-3 Standard”) using high order modulation schemes.

### Data Rate vs. Frequency

Bandwidth-efficient modulation schemes allow, as a general rule, transmission of data at rates of 1 to 10 bits per Hz of available bandwidth in spectral ranges including radio wave lengths to microwave wavelengths. Data transmission requirements of 1 to tens of Gbps thus would require hundreds of MHz of available bandwidth for transmission. Equitable sharing of the frequency spectrum between radio, television, telephone, emergency services, military and other services typically limits specific frequency band allocations to about 10% fractional bandwidth (i.e., a range of frequencies equal to about 10% of center frequency). AM radio's large fractional bandwidth (e.g., 550 to 1650 GHz) is an anomaly; FM radio, at 20% fractional bandwidth, is also atypical compared to more recent frequency allocations, which rarely exceed 10% fractional bandwidth.

### Need for High Performance Modulators

As data rates increase so to do the demands on the performance of modulators used in wireless transmitters. Prior art methods of modulating are not sufficient to meet the simultaneous demands for both high data rates and moderately high power output.

What is needed are better modulators that meet the increasing simultaneous demands for both high data rates and moderately high power output.

### SUMMARY OF THE INVENTION

The present invention provides a modulator for high data rate communication at frequencies greater than 70 MHz and at data rates of about 1.25 Gbps or greater. The modulator includes a resonant LC circuit including a diode which is back-biased for “off” (i.e., no transmit) and forward biased for “on” (or transmit). In preferred embodiments the modulator is a part of high performance transceivers for wireless, millimeter wave communications links. A preferred embodiment provides a communication link of more than eight miles which operates within the 71 to 76 GHz portion of the millimeter spectrum and provides data transmission rates of 1.25 Gbps with bit error rates of less than 10⁻¹⁰. A first transceiver transmits at a first bandwidth and receives at a second bandwidth both within the above spectral range. A second transceiver transmits at the second bandwidth and receives at the first bandwidth. The transceivers are equipped with antennas providing beam divergence small enough to ensure efficient spatial and directional partitioning of the data channels so that an almost unlimited number of transceivers will be able to simultaneously use the same spectrum. In a preferred embodiment the first and second spectral ranges are 71.8+/−0.63 GHz and 73.8+/−0.63 GHz and the half power beam width is about 0.2 degrees or less. Preferably, a backup transceiver set is provided which would take over the link in the event of very bad weather conditions.

### BRIEF DESCRIPTION OF THE DRAWINGS

FIG. 1 is a sketch of a full duplex millimeter wave link.

FIG. 2A is a block diagram showing a 1.25 Gbps transmitter operating at millimeter-wave frequencies.

FIG. 2B is a block diagram showing a 1.25 Gbps receiver operating at millimeter-wave frequencies.

FIGS. 3A and 3B show spectrum plan of 1.25 Gbps digital radio operating at 71.8-73.8 GHz frequencies.

FIGS. 4A and 4B are measured output voltages (eye diagrams) from a millimeter-wave receiver at 60 dB signal attenuation and 1.25 Gbps data rate.

FIGS. 5 is a block diagram showing layout of a separate transmit and receive antenna configuration.

FIG. 6 is a block diagram showing layout of a single-antenna configuration millimeter-wave transceiver.

FIG. 7 displays path loss over a 41-hour period for a prototype demonstration.

FIGS. 8A and B show features of a prior art modulator.

FIGS. 9A and B and FIGS. 10A and B show the results of one attempt to construct a high frequency rf communication system using a diode which is back-biased for “on” and forward biased for “off”.

FIGS. 11A and B and 12A and B show a preferred embodiment of the present invention comprising a tuning stub to produce a resonant LC circuit to provide a high frequency rf modulation in which a diode is back-biased for “off” (i.e., no transmit) and forward biased for “on” (or transmit).

### DETAILED DESCRIPTION OF PREFERRED EMBODIMENTS

### Need For High Data Rate Transceivers

The value of a wireless communications link depends on many factors including the distance over which it can reliably operate. The longer the operational range of a set of hardware for a communications link, the greater its potential economic value. While the same hardware can be applied to short-range situations (corresponding to reduced economic value) when the hardware is applied to longer-range situations the higher economic values can be realized. For comparison, optical fiber typically costs $500,000 per mile or more to install in a metropolitan environment. Thus for situations requiring a large amount of bandwidth (large compared with the capability of twisted copper pairs and low frequency wireless), but not so large as to require more than about 1 gigabit per second, the instant invention has an economic value which can approach the cost of optical fiber. Thus an approximately 1 gigabit per second wireless link can approach a competitive worth of about 2.5 million dollars if it can operate over a 5 mile distance or 5 million dollars if it can operate over a 10 mile distance. Thus longer range is economically very desirable.

With the goal of providing high data rate links (e.g. 1.25 Gbs) over long distances (of the order of 10 miles (16 km)), it is informative to calculate the amount of signal loss naturally occurring over such a long distance. Assuming operation at about 73 GHz at sea level with 85% relative humidity at 25 C. using 1.2-meter (4-foot) diameter antennas at both end implies a signal loss of 60 dB for a 10 mile (16 km) link.

### Prototype Demonstration

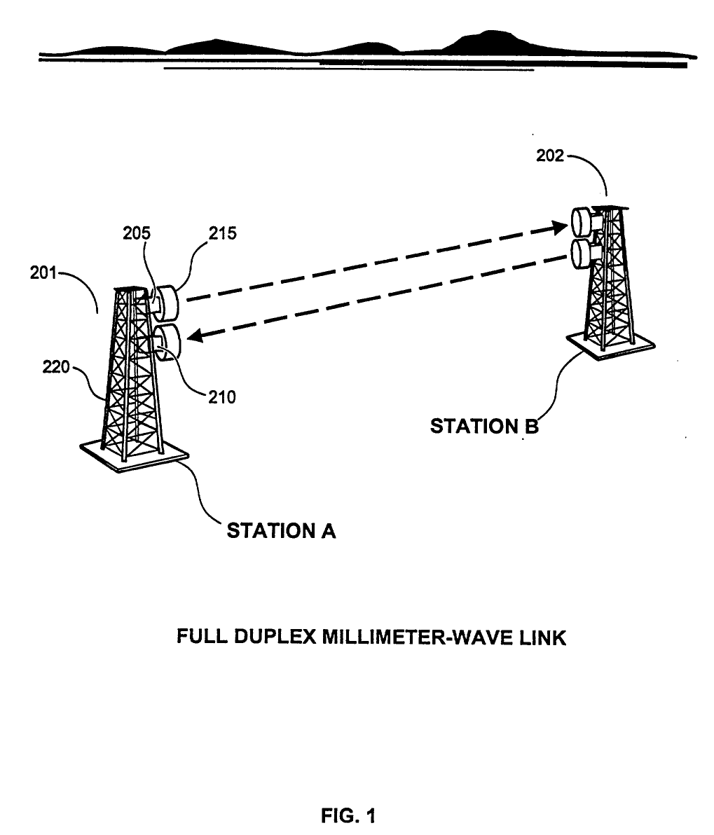

A prototype demonstration of the millimeter-wave transmitter and receiver useful for the present invention is described by reference to FIGS. 1 to 7. With this embodiment the Applicants have demonstrated digital data transmission in the 71 to 76 GHz range at 1.25 Gbps with a bit error rate below 10⁻¹².

### Transceiver System

FIG. 1 shows how a full duplex wireless data link between Station A and Station B is accomplished by using a mm-wave transceiver at each station site. The transceiver hardware comprises a millimeter wave transmitter and receiver pair including a pair of millimeter-wave antennas. The millimeter-wave transmitter signal is amplitude modulated with a high-speed diode switch. The receiver includes a millimeter-wave down converter that translates the received signal spectrum from 71.8-73.8 GHz frequencies to a 2.0±0.625 GHz intermediate frequency (IF) range. It also includes an automatic gain control circuit (AGC), detector and data/clock recovery circuit to extract base-band digital data sent by the transmitter.

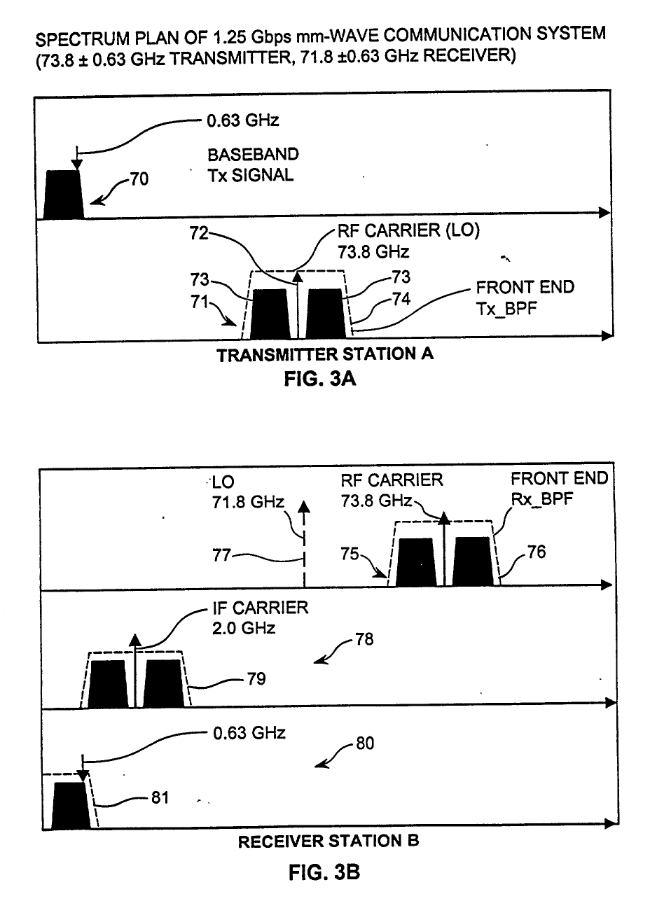

Millimeter wave hardware used to support full duplex wireless link comprises two transmitter-receiver pairs operating in parallel. The transmitter at Station A transmits at 73.8 GHz center frequency and receiver at Station B uses a local oscillator at 71.8 GHz to down convert incoming radio signal to an intermediate frequency (IF) centered at 2 GHz. The transmitter at Station B transmits at 71.8 GHz center frequency and a 73.8 GHz local oscillator is used in the receiver at Station A. In both cases the IF frequency remains centered at the same 2 GHz frequency. Each transceiver uses a single mm-wave local oscillator for both transmitter and receiver circuits, but the frequency used in Stations A and B differ by 2 GHz as shown in FIGS. 3A and 3B.

### Millimeter Wave Link Configuration

A sketch of a full-duplex wireless link between stations A and B is shown in FIG. 1. In a preferred embodiment, the link is formed using millimeter wave transceivers designated as 201 and 202, one transceiver per station. The transceiver at station A comprises a transmitter 205 and a receiver 210 that are connected to parabolic dish antenna 215 and parabolic dish antenna 220, respectively. The transceiver at station A is attached to a rigid support structure 230. The hardware configuration of station B is similar to that of station A. A transceiver at station B comprises a transmitter 250 and a receiver 255 that are connected to parabolic dish antenna 270 and parabolic dish antenna 265, respectively. The transceiver at station B is attached to a rigid support structure 280. A millimeter wave signal transmitted from Station A to Station B has a center frequency at 73.8 GHz and a signal transmitted from Station B to Station A is centered at 71.8 GHz. The signals transmitted in opposite directions have polarization perpendicular to each other to reduce cross talk interference.

### Millimeter Wave Transmitters and Receivers

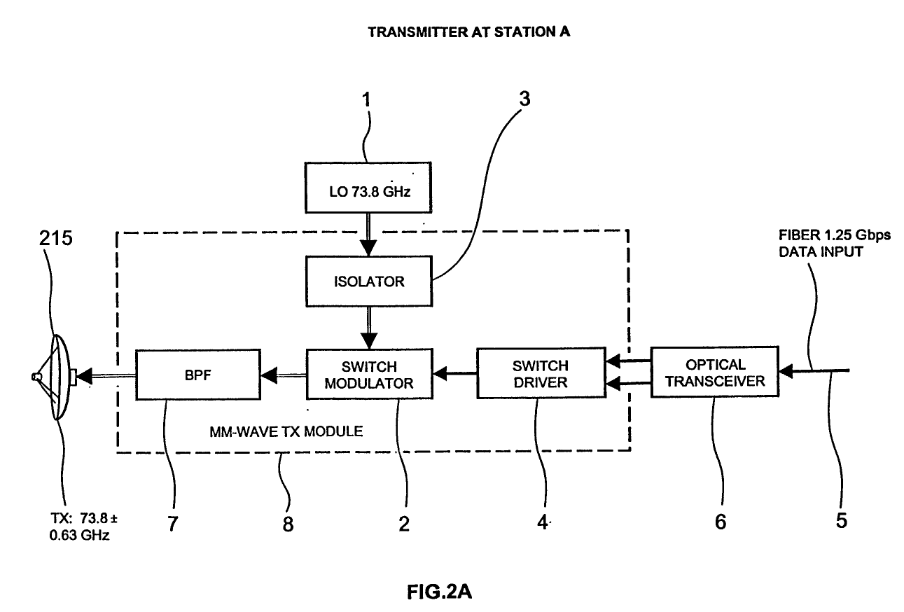

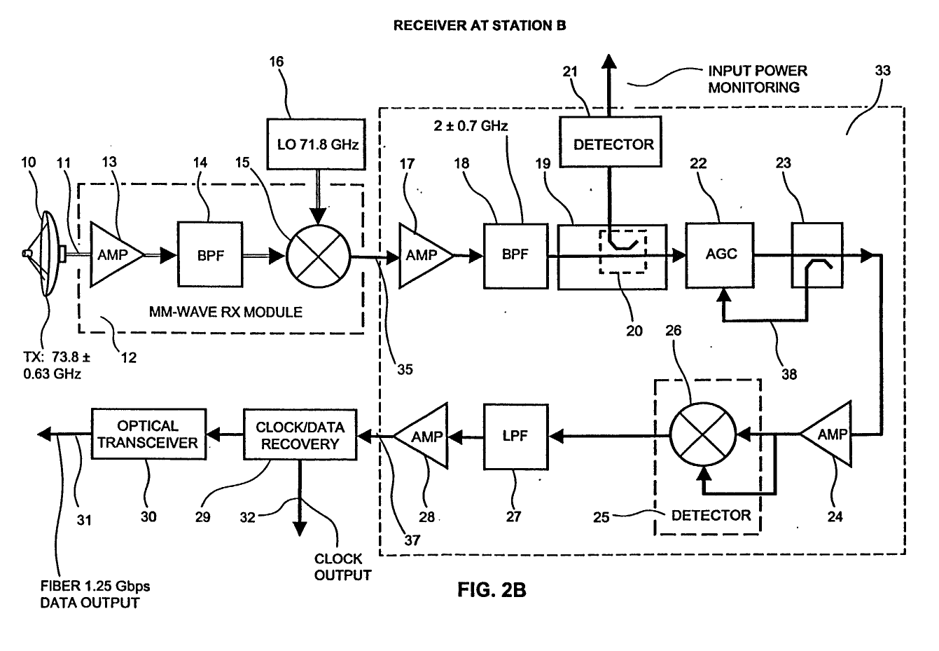

A one-way digital wireless link is supported by a millimeter-wave transmitter located at Station A and a receiver located at station B. A block diagram of the transmitter is shown in FIG. 2A. A block diagram of the receiver is illustrated in FIG. 2B. In the transmitter, the transmit power is generated with a cavity-tuned Gunn diode local oscillator (LO) 1 resonating at 73.8 GHz (available, for example, as Model GE-738 from Spacek Labs Inc., Santa Barbara, Calif.). The power from LO 1 is amplitude modulated by a fast diode switch modulator 2. The modulator allows at least 15 dB modulation depth which is adjusted to optimize link performance. Isolator 3 (available, for example, as Model WJE-WI from MRI Inc., Chino, Calif.) disposed between modulator 2 and LO 1 prevents power reflected by the switch modulator 2 from entering and affecting LO 1. The diode switch modulator 2 is controlled by switch driver 4 at 1.25 Gigabit per second data rate in accordance with the Gigabit-Ethernet standard (802.3z by the IEEE Standards Association). The modulating signal is brought in on optical fiber 5, converted to an electrical signal in optical transceiver 6 (for example, a Finisar model FTRJ-8519-1 operating at 850 nm optical wavelength). The amplitude-modulated mm-wave signal is filtered in a 1.6 GHz wide pass-band between 73 and 74.6 GHz using wave-guide band pass filter 7 (such as a septum or E-plane wave-guide filter). Components 2,3, 4 and 7 are packaged in a millimeter-wave module 8. A heat sink is provided to the module and each component to reduce temperature drift of their characteristics. From the wave guide filter 7, the millimeter wave signal propagates to a Cassegrain dish antenna 215 where it is radiated into free space with vertical polarization.

The receiver at station B as shown in FIG. 2B collects incoming vertical polarized millimeter wave power with a Cassegrain antenna 265 (available, for example as Model CRA-R48G from Millitech) and channels it into wave guide 11 that connects to a millimeter-wave receiver module 12. At the front end of the receiver is a 20 dB gain low noise amplifier 13. After amplification, the signal is passed on to a wave guide band pass filter 14 that rejects signal outside the 73-74.6 GHz frequency band. This filtered signal is then down converted to a 2±0.625 GHz intermediate frequency band using a mixer 15 (available, for example, as Model M74-2 from Spacek Labs Inc., Santa Barbara, Calif.) and local Gunn oscillator 16 operating at 71.8 GHz frequency (available, for example, as Model GE-718 from Spacek Labs Inc., Santa Barbara, Calif.). The resulting intermediate frequency (IF) signal 35 is converted into a base band signal 37 in IF circuit 33. In the IF circuit 33 the intermediate frequency signal 35 is amplified by amplifier 17 (available, for example, as Model ERA-1, MiniCircuits, Brooklyn, N.Y.) and filtered by a microstrip band pass filter 18 having a pass-band between 1.2 and 2.8 GHz. The filter 18 has flat group delay response with less than then 100 ps delay time variation within its passband to minimize time jitter in the transmitted digital signal. A small fraction of the signal is picked off a microstrip line 19 with a coupler 20 (available, for example, as Model D18P from MiniCircuits, Brooklyn, N.Y.) and converted into low frequency voltage by a detector 21 (available, for example, as Model DTM180 from Herotek Inc., San Jose, Calif.) for the purpose of monitoring signal power. The remaining signal is directed to an automatic gain control circuit (AGC) 22 (available, for example, as Model HMC346MS8G from Hittite Corp., Chelmsford, Mass.) that maintains stable power output for the input power variations as large as 30 dB. A signal-level feedback 38 for AGC 22 is provided by coupler 23. An amplifier 24 brings signal power to a level required for proper operation of a detector 25. A custom microwave detector circuit is required to provide the 700 Mhz of video bandwidth. The base band component of the resulting detected signal is separated from the high frequency components by a low pass filter (Pass band DC-1000 MHz) 27 (available, for example, as Model SCLF-1000 from MiniCircuits, Brooklyn, N.Y.) and amplified in amplifier 28 to a level adequate for further processing. The filtered base band signal 37 enters clock and data recovery circuit 29 (available, for example, as Model VSC8122 from Vitesse Semiconductor Corp., Camarillo, Calif.) for conditioning. Data output of the data recovery circuit 29 is connected to optical transceiver 30 (available, for example, as Model FTRJ-8519 from Finisar Corp., Sunnyvale, Calif.) that converts the electrical voltage signals into optical signals which are transmitted through optical fiber cable 31. Clock output 32 of the clock/data recovery circuit is provided for circuit testing purposes.

Signal spectrum transformation from the base band input at the Transmitter A to the base band output at the Receiver B is illustrated in FIG. 3A and 3B. At a 1.25 Gbps data rate, the base-band signal spectrum occupies a frequency band 70 from approximately 120 MHz to approximately 630 MHz (0.63 GHz). With signal spectrum limited to this frequency band by a filter, the 1.25 Gbps data rate consisting of alternating high and low voltage levels will correspond to a sinusoidal signal at 625 MHz frequency. An output spectrum 71 of transmitter at station A comprises a center carrier 72 at 73.8 GHz and two side bands 73 that mirror the base band signal relative to the center carrier. The strength of the center carrier relative to the strength of the side bands can be adjusted by changing the modulation depth of the signal in modulator 2. The bandwidth of the transmitted signal is limited by the wave guide band pass filter 7 with characteristics shown as 74. As signal from transmitter A arrives at the receiver B its spectrum shape 75 remains similar to that of transmitted signal 71. After amplification by low noise amplifier 13 much of the white thermal noise is removed from the spectrum by the receiver band pass filter 14 whose characteristic is shown as 76. Local oscillator signal of the receiver at 71.8 GHz is shown as 77. In millimeter-wave mixer 15 the received signal having spectrum 75 and local oscillator having spectrum 77 interact to produce intermediate frequency spectrum 78. The intermediate frequency spectrum 78 is a replica of spectrum 75 translated to lower frequencies. The intermediate frequency spectrum 78 is centered at 2 GHz and is band-limited with filter 18 to remove all other spectral components. Upon detection, the intermediate spectrum 78 is transformed into a base band spectrum 80 and is limited with low pass filter 27 to retain signal components contained in the original transmitted 1.25 Gbps digital signal. The low-pass filter 27 characteristic is shown as 81.

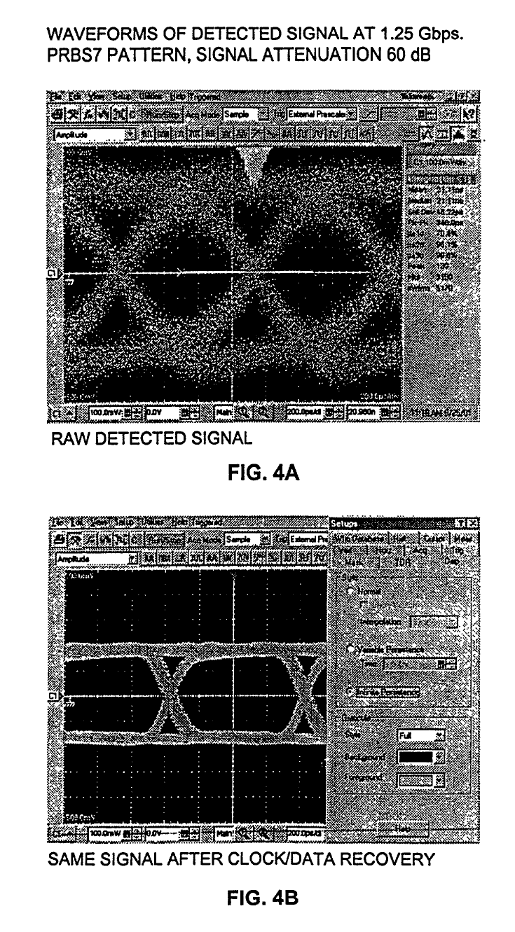

FIGS. 4A and 4B show measured eye diagrams of a 1.25 Mbps pseudo random (PRBS7) digital signal transmitted from Transmitter A and received by Receiver B. The raw detected signal attenuated by 60 dB as it propagated between stations A and B is shown in FIG. 4A. In spite of the noise present, the imbedded signal was recovered with 10⁻¹⁰ bit error rate (BER). Similar measurements with somewhat less signal attenuation, 58 dB, gave BER results of just 10⁻¹². Data/clock recovery circuit 29, as shown in FIG. 2, takes the raw detected signal and converts into a cleaner signal with low jitter as shown in FIG. 4B without considerably affecting its BER characteristics. The data/clock recovery circuit 29 provides a standardized output compatible with optical networking equipment.

Another one-way link is used to complement the above-described unidirectional link to create a full-duplex link shown in FIG. 1. The transmitter and receiver configuration used in this second link is similar to that shown in FIGS. 2A and 2B. It differs from the one shown in FIG. 2A in that the local oscillator of transmitter located at Station B resonates at the frequency 71.8 GHz, while the local oscillator in the receiver located at Station A resonates at the frequency 73.8 GHz and the mm-wave signal propagating from Station B to Station A is horizontally rather than vertically polarized. A person skilled in the art would also appreciate that band pass characteristics of the millimeter wave components used in the millimeter-wave modules 8 and 12 including band pass filters, low noise amplifier and mixer need to be adjusted accordingly to accommodate 1.25 Gbps signals with center frequencies determined by the local oscillators used in the second link.

### Separate Antennas Transceiver Configuration

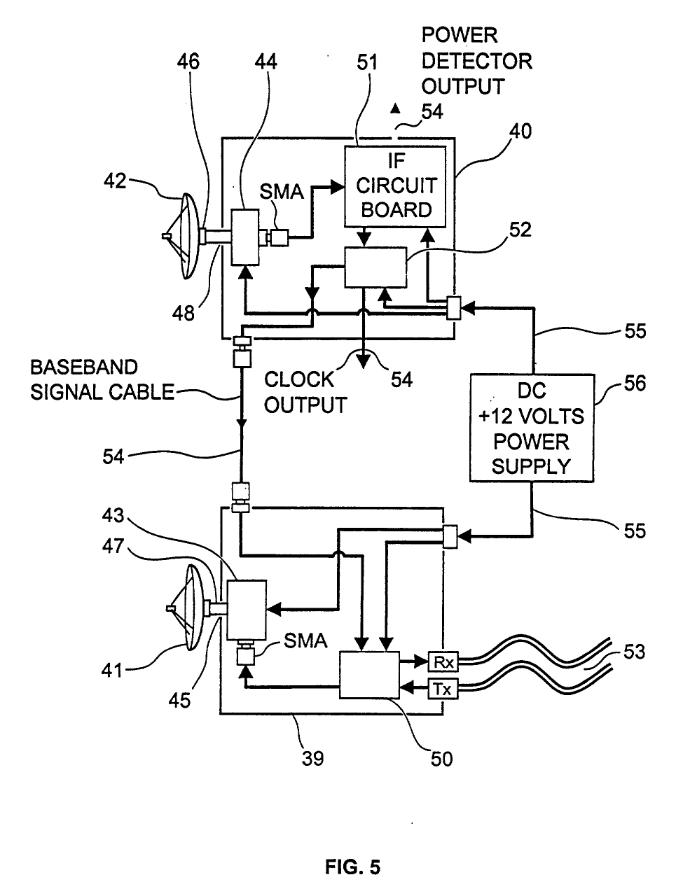

In the separate-antennas transceiver configuration shown in FIG. 1 each of the receivers and transmitters uses individual antennas for millimeter wave signal transmission and reception. This configuration maximizes signal isolation between receiver and transmitter deployed in the same location as shown in FIG. 1. FIG. 5 shows the transceiver hardware layout and connections for such configuration. Electronic components of the transceiver are protected by hermetically sealed metal transmitter enclosure 39 and receiver enclosure 40. Parabolic transmitting antenna 41 and receiving antenna 42 are attached to the enclosures and antenna horns 45 and 46 connect to millimeter wave transmitter module 43 and receiver module 44 via hermetically sealed ports 47 and 48 in the enclosures 39 and 40 respectively. Electric power to the transceiver is provided by an external +12 Volts power supply 56. Millimeter wave transmitter module 43 and optical board 50 that provides modulating input for the transmitter are packaged inside transmitter enclosure 39. Optical board 50 converts optical signal brought in on fiber 53 into voltage signal.

Millimeter-wave receiver module 44, intermediate frequency board 51, clock/data recovery circuit board 52 and optical circuit board 57 are disposed inside receiver enclosure 40. An intermediate frequency signal detected by the IF board 51 is conditioned in the clock recovery board 52 and then transmitted by optical circuit board 57 into fiber 58. Hermetically sealed connectors attached to the enclosures provide power input and signal input/output from/to externally connected optical fiber 53 and optical fiber 58, power detector output 59, clock output 54 and power cables 55. RFI/EMI filters 60 protect receiver and transmitter circuits against external interference induced in the power cables 55.

### Single Antenna Transceiver Configuration

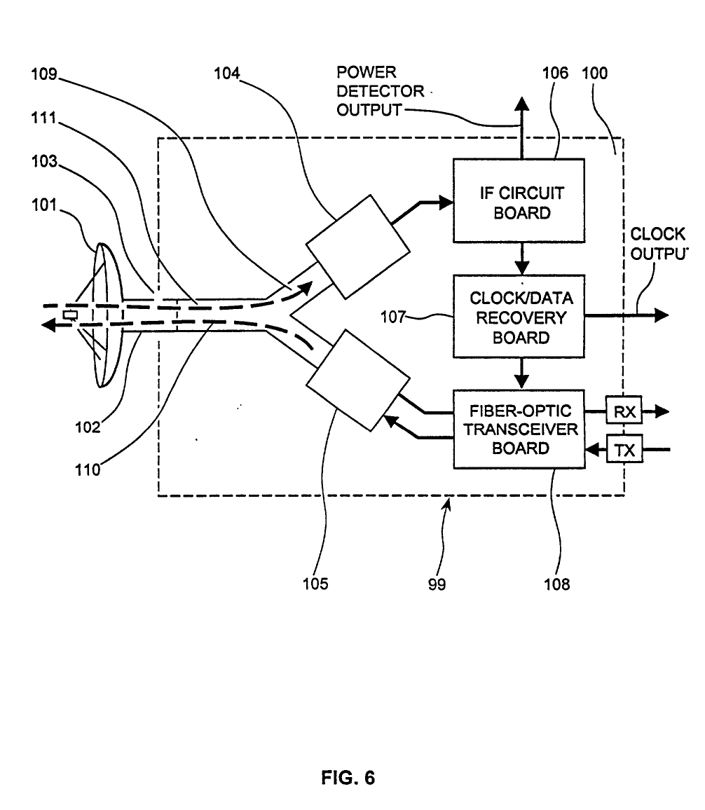

In another embodiment, called a single antenna configuration, both transmitter and receiver use a common dish antenna at each station location. An example of a single antenna configuration is shown in FIG. 6 as 99. In a single antenna configuration electronic components of both transmitter and receiver are packaged inside the same hermetically sealed transceiver enclosure 100. Receiving and transmitting antenna 101 has horn 102 that communicates with the millimeter wave components inside the enclosure via hermetically sealed port 103. Millimeter-wave receiver 104 and transmitter 105 modules, IF receiver 106, clock/data recovery 107 and fiber/optic transceiver 108 boards are similar to those used in the separate antennas transceiver configuration. To transmit and receive signals with a single antenna, transceiver 99 includes a duplexer component 109 disposed between the antenna horn and millimeter wave transmitter and receiver modules. Duplexer 109 channels millimeter-wave power 110 generated by the transmitter 105 to the antenna horn and simultaneously prevents it from entering receiver 104. The received power 111 is directed to the receiver 104 and does not enter transmitter. An off-the-shelf component that can be used for duplexer 109 is orthomode transducer such as model OMT-12RR125 manufactured by Millitech Corp. The OMT can provide at least 25 dB isolation between receiver and transmitter ports.

### Measured Path Loss

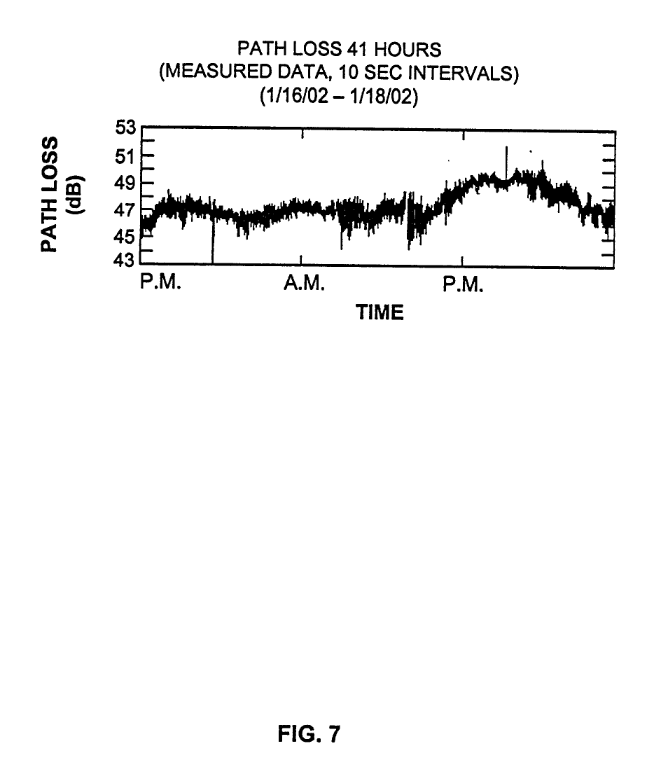

FIG. 7 shows measured data for the path loss of communication link incorporating the radio transceiver of the instant invention. The data span a 41-hour period and were taken at 10 second intervals. The link spanned a distance of 8 miles (13 km). The variations in link loss demonstrated in FIG. 7 are primarily due to weather variations over time (dominated by humidity changes).

### Prior Art Modulators

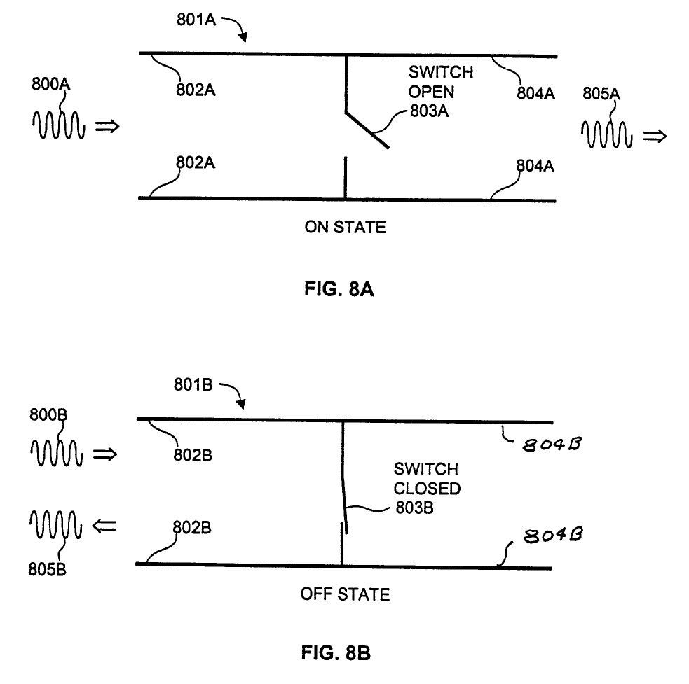

FIGS. 8A and 8B shows a highly simplified schematic of a conventional prior art rf modulator in two different states, “on” and “off”, respectively. An RF signal 800A enters transmission line 801A from the left at port 802A. A modulator switch 803A, shown in the switch-open state, or “on” state, in FIG. 8A, is used to control the amount of rf signal 805A, that continues along transmission line 801A and on to exit to the right at port 804A.

FIG. 8B shows the modulator in the switch-closed, or “off” state. In this case, switch 803B acts as a short circuit on the transmission line 301B, hence causing the rf power 800B to reflect back toward port 802B and producing a greatly diminished signal at port 804B. This is the essence of the operation of most prior art modulators.

So long as the frequencies of operation (both modulation rate and rf frequency) are kept low enough, the conventional modulator of FIGS. 8A and 8B perform satisfactorily. However, when either of the modulation rate or rf frequency increase to the range of about 50 GHz, these conventional modulators suffer diminished performance.

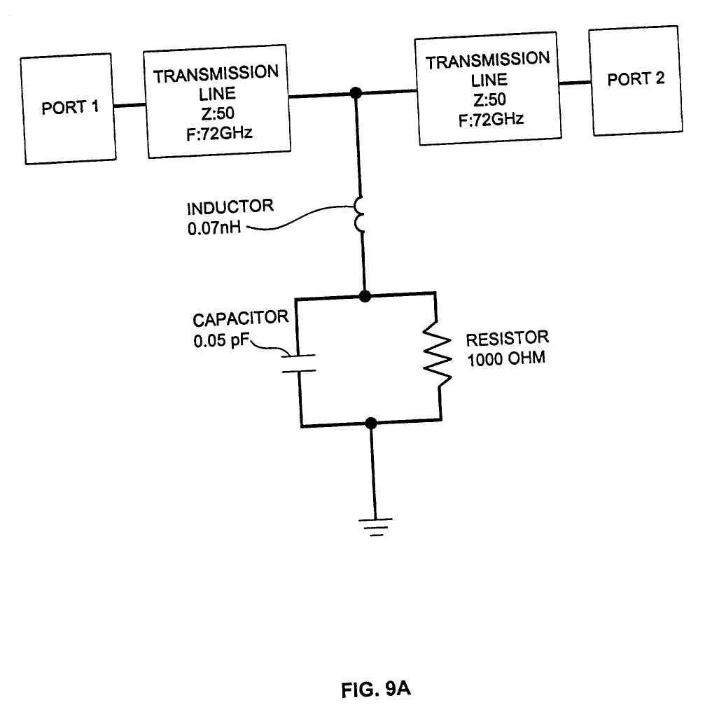

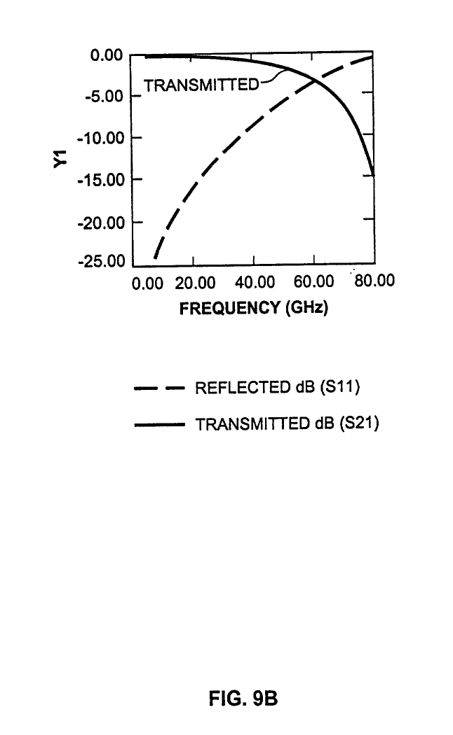

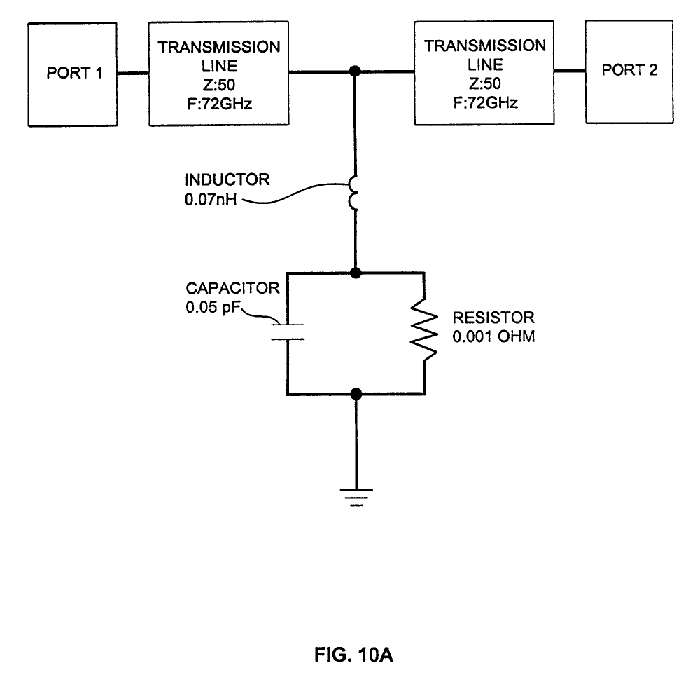

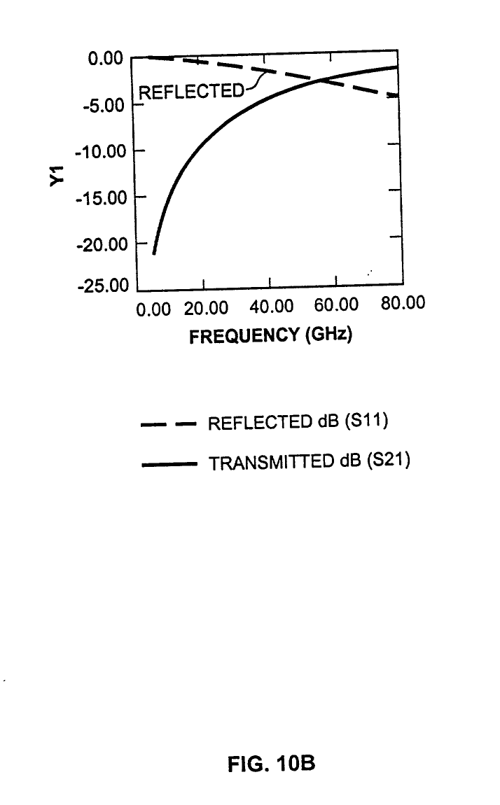

FIG. 9A shows a simplified schematic of a diode-based modulator that operates well in the range of 60 to 120 GHz. In this embodiment a diode MA 4E2038, available from M/A-COM, at Lowell, Mass. or equivalent is modified for use in a high frequency communication modular. FIG. 9B shows the simulated transmission and reflection signals for this diode in a back-biased, switch-open state. At low frequency, the transmission is very high, and the reflection is very low. Unfortunately, when one looks at the higher frequencies, the performance of this diode switch degrades rapidly as 60 GHz is approached. At this frequency, the amount of reflection becomes comparable with the amount of transmission and hence the notion of a good “on” state becomes seriously compromised.

A similar situation occurs with the “off” state as shown in FIGS. 10A and 10B. FIG. 10A shows a simplified schematic of the diode-based modulator of FIG. 9A, but in the switch-closed or so-call “off” state. FIG. 10B shows the corresponding simulated transmission and reflection signals for this simulated diode in a forward-biased, switch-closed state. If one looks only at the low frequency performance, the transmission is very low as in FIG. 8B, and the reflection is very high also as in FIG. 8B. Unfortunately, when one looks at the higher frequencies, the performance of this diode switch degrades rapidly as 60 GHz is approached. At this frequency, the amount of transmission become comparable with the amount of reflection and hence the notion of a good “off” state also becomes seriously compromised.

### High Performance Modulator of the Instant Invention

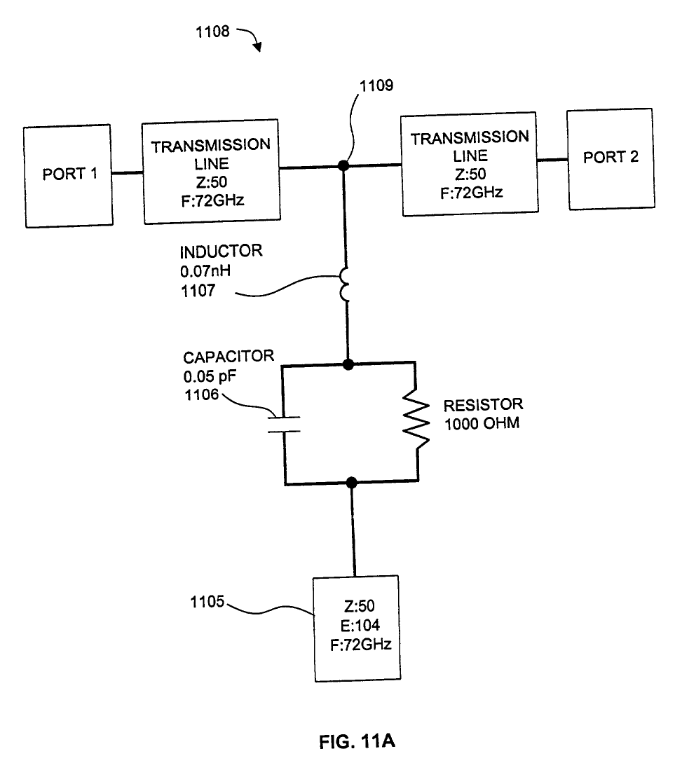

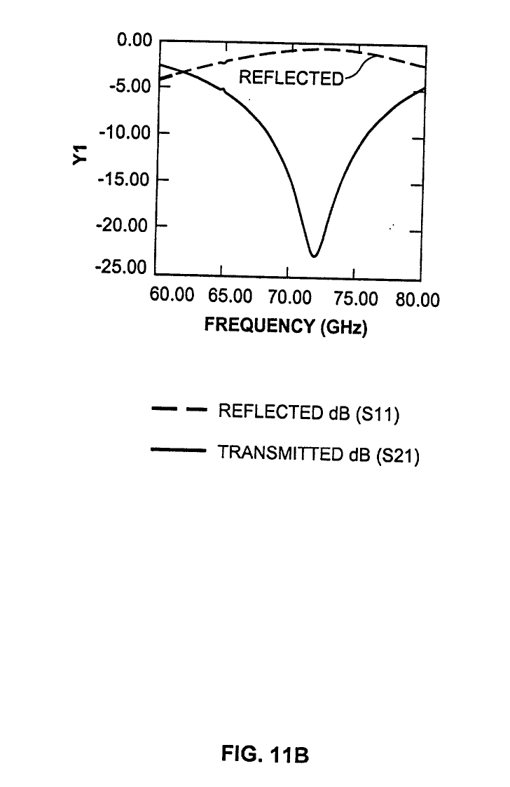

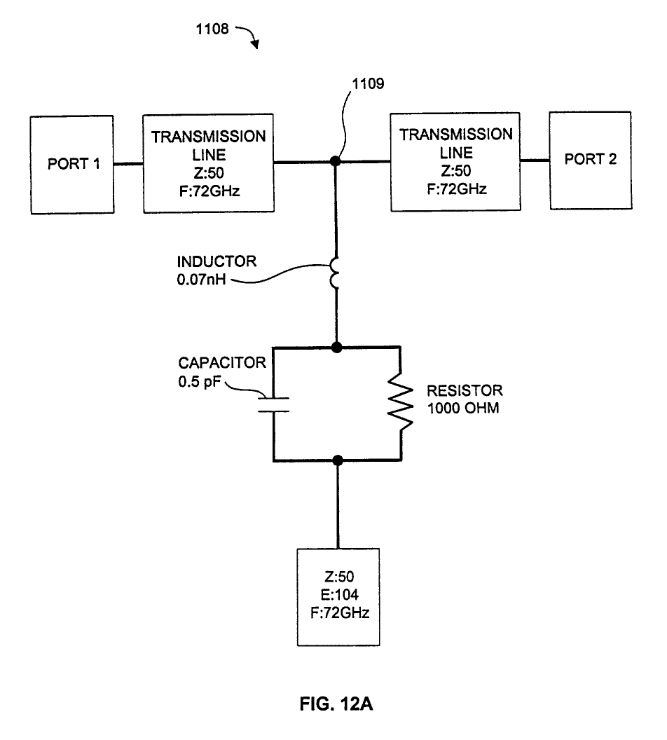

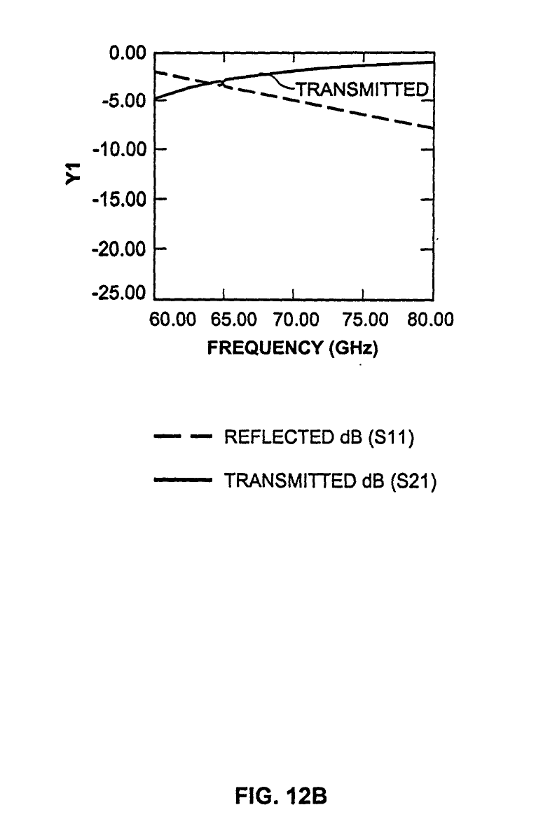

To produce a modulator that is capable of high data rate modulation of high frequency signals. This greatly improved performance is the result of the addition of a tuning stub 115 to diode MA4E2038 as shown in FIG. 11A. The modified diode-based modulator that can operate at in the range of 72 GHz. FIG. 11B shows the simulated transmission and reflection signals for this simulated diode in a back-biased, switch-open state. In the frequency range of about 72 GHz, the reflection is very high, and the transmission is very low. The reader should note that the switching convention used for this embodiment is opposite that of the conventional modulator. This is because in the “diode-off” state, the tuning stub 1105, diode capacitance 1106 and lead inductance 1107 all combine to form a resonant LC circuit which, when properly tuned, presents an rf short across the transmission line at the point 1109 at or near 72 GHz.

FIG. 12A shows the same circuit as FIG. 11A except now in the forward-biased diode state. In this case, at or near 72 GHz, the transmitted signal becomes large while the reflected signal becomes relatively small as shown in FIG. 12B. Again, this is consistent with a modulator that works with an “on-off” relationship which is opposite that of the conventional diode modulator with regards to the bias condition of the diode. In the state shown in FIG. 12A, the tuned circuit has been thrown “out of tune” (as far as 72 GHz transmission is concerned) by the application of a forward bias to the diode.

Worthy of special note is the fact that the model of FIGS. 12A and 12B assumes no conductive contribution to the diode “switching” or modulation of the rf signal in the transmission line. In this case, it is assumed that the capacitance of the diode has changed (increased by a factor of 10) as a result of a slight forward bias on the diode (from the modulator signal). The fact that diodes display a large increase in junction capacitance when slightly forward-biased is well known (see, for example, page 287 of RF Circuit Design, Theory and Applications, by R. Ludwig and R. Bretchko, Prentice Hall ©2000). Thus, the instant invention can modulate an rf signal by changes induced in a diodes capacitance rather than by changes induced in a diodes conductance.

An implication of this novel mode of modulation is that a potentially power consumptive situation in the switching diode can be avoided. With a conventional modulator that uses conductive switching, a large amount of power is resistively dissipated when the resistance of the diode crosses through the value corresponding to the characteristic impedence of the transmission line. For example, when a diode becomes forward biased to a resistance of 50 ohms when used to modulate a 50 ohm transmission line maximum power transfer to (and dissipation occurs in) the diode junction resistance. During this “matched” condition half the power can be dissipated. Thus, during a conductive transition there is a time when the switching process is very inefficient. By contrast, the modulator of the present invention need not drive the diode through such a lossy transition. Hence the inefficient process that occurs during conventional conductance switching is avoided altogether.

### Very Narrow Beam Width

A dish antenna of four-foot diameter projects a half-power beam width of about 0.2 degrees at 72 GHz. The full-power beam width (to first nulls in antenna pattern) is narrower than 0.45 degrees. This suggests that about 800 independent beams could be projected azimuthally around an equator from a single transmitter location, without mutual interference, from an array of 4-foot dishes. At a distance of ten miles, two receivers placed 400 feet apart can receive independent data channels from the same transmitter location. Conversely, two receivers in a single location can discriminate independent data channels from two transmitters ten miles away, even when the transmitters are as close as 400 feet apart. Larger dishes can be used for even more directivity.

### Rigid Antenna Support

A communication beam having a half-power beam width of only about 0.2 degrees requires an extremely stable antenna support. Prior art antenna towers such as those used for microwave communication typically are designed for angular stability of about 0.6 to 1.1 degrees or more. Therefore, the present invention requires much better control of beam direction. For good performance the receiving antenna should be located at all times within the half power foot print of the transmitted beam. At 10 miles the half power footprint of a 0.2-degree beam is about 150 feet. During initial alignment the beam should be directed so that the receiving transceiver antenna is located approximately at the center of the half-power beam width footprint area. The support for the transmitter antenna should be rigid enough so that the beam direction does not change enough so that the receiving transceiver antenna is outside the half-power footprint. Thus, in this example the transmitting antenna should be directionally stable to within +/−0.09 degrees.

This rigid support of the antenna not only assures continued communication between the two transceivers as designed but the narrow beam widths and rigid antenna support reduces the possibility of interference with any nearby links operating in the same spectral band.

### Backup Microwave Transceiver Pair

During severe weather conditions data transmission quality will deteriorate at millimeter wave frequencies. Therefore, in preferred embodiments of the present invention a backup communication link is provided which automatically goes into action whenever a predetermined drop-off in quality transmission is detected. A preferred backup system is a microwave transceiver pair operating in the 10.7-11.7 GHz band. This frequency band is already allocated by the FCC for fixed point-to-point operation. FCC service rules parcel the band into channels of 40-MHz maximum bandwidth, limiting the maximum data rate for digital transmissions to 45 Mbps full duplex. Transceivers offering this data rate within this band are available off-the-shelf from vendors such as Western Multiplex Corporation (Models Lynx DS-3, Tsunami 100BaseT), and DMC Stratex Networks (Model DXR700 and Altium 155). The digital radios are licensed under FCC Part 101 regulations. The microwave antennas are Cassegrain dish antennas of 24-inch diameter. At this diameter, the half-power beamwidth of the dish antenna is 3.0 degrees, and the full-power beamwidth is 7.4 degrees, so the risk of interference is higher than for MMW antennas. To compensate this, the FCC allocates twelve separate transmit and twelve separate receive channels for spectrum coordination within the 10.7-11.7 GHz band. Sensing of a millimeter wave link failure and switching to redundant microwave channel is an existing automated feature of the network routing switching hardware available off-the-shelf from vendors such as Cisco, Foundry Networks and Juniper Networks.

### Narrow Beam Width Antennas

The narrow antenna beam widths afforded at millimeter-wave frequencies allow for geographical portioning of the airwaves, which is impossible at lower frequencies. This fact eliminates the need for band parceling (frequency sharing), and so enables wireless communications over a much larger bandwidth, and thus at much higher data rates, than were ever previously possible at lower RF frequencies.

The ability to manufacture and deploy antennas with beam widths narrow enough to ensure non-interference, requires mechanical tolerances, pointing accuracies, and electronic beam steering/tracking capabilities, which exceed the capabilities of the prior art in communications antennas. An preferred antenna for long-range communication at frequencies above 70 GHz has gain in excess of 50 dB, 100 times higher than direct-broadcast satellite dishes for the home, and 30 times higher than high-resolution weather radar antennas on aircraft. However, where interference is not a potential problem, antennas with dB gains of 40 to 45 may be preferred.

Most antennas used for high-gain applications utilize a large parabolic primary collector in one of a variety of geometries. The prime-focus antenna places the receiver directly at the focus of the parabola. The Cassegrainian antenna places a convex hyperboloidal secondary reflector in front of the focus to reflect the focus back through an aperture in the primary to allow mounting the receiver behind the dish. (This is convenient since the dish is typically supported from behind as well.) The Gregorian antenna is similar to the Cassegrainian antenna, except that the secondary mirror is a concave ellipsoid placed in back of the parabola's focus. An offset parabola rotates the focus away from the center of the dish for less aperture blockage and improved mounting geometry. Cassegrainian, prime focus, and offset parabolic antennas are the preferred dish geometries for the MMW communication system.

A preferred primary dish reflector is a conductive parabola. The preferred surface tolerance on the dish is about 15 thousandths of an inch (15 mils) for applications below 40 GHz, but closer to 5 mils for use at 72 GHz. Typical hydroformed aluminum dishes give 15-mil surface tolerances, although double-skinned laminates (using two aluminum layers surrounding a spacer layer) could improve this to 5 mils. The secondary reflector in the Cassegrainian geometry is a small, machined aluminum “lollipop” which can be made to 1-mil tolerance without difficulty. Mounts for secondary reflectors and receiver waveguide horns preferably comprise mechanical fine-tuning adjustment for in-situ alignment on an antenna test range.

### Flat Panel Antenna

Another preferred antenna for long-range MMW communication is a flat-panel slot array antenna such as that described by one of the present inventors and others in U.S. Pat. No. 6,037,908, issued Mar. 14, 2000 which is hereby incorporated herein by reference. That antenna is a planar phased array antenna propagating a traveling wave through the radiating aperture in a transverse electromagnetic (TEM) mode. A communications antenna would comprise a variant of that antenna incorporating the planar phased array, but eliminating the frequency-scanning characteristics of the antenna in the prior art by adding a hybrid traveling-wave/corporate feed. Flat plates holding a 5-mil surface tolerance are substantially cheaper and easier to fabricate than parabolic surfaces. Planar slot arrays utilize circuit-board processing techniques (e.g. photolithography), which are inherently very precise, rather than expensive high-precision machining.

### Coarse and Fine Pointing

Pointing a high-gain antenna requires coarse and fine positioning. Coarse positioning can be accomplished initially using a visual sight such as a bore-sighted riflescope or laser pointer. The antenna is locked in its final coarse position prior to fine-tuning. The fine adjustment is performed with the remote transmitter turned on. A power meter connected to the receiver is monitored for maximum power as the fine positioner is adjusted and locked down.

At gain levels above 50 dB, wind loading and tower or building flexure can cause an unacceptable level of beam wander. A flimsy antenna mount could not only result in loss of service to a wireless customer; it could inadvertently cause interference with other licensed beam paths. In order to maintain transmission only within a specific “pipe,” some method for electronic beam steering may be required.

### Other Embodiments

Any millimeter-wave carrier frequency 71-76 GHz, 81-86 GHz, and 92-100 GHz, can be utilized in the practice of this invention. Likewise any of the several currently allocated microwave bands, such as 5.2-5.9 GHz, 5.9-6.9 GHz, 10.7-11.7 GHz, 17.7-19.7 GHz, and 21.2-23.6 GHz can be utilized for the backup link. The modulation bandwidth of both the MMW and microwave channels can be increased, limited again only by FCC spectrum allocations. Also, any flat, conformal, or shaped antenna capable of transmitting the modulated carrier over the link distance in a means consistent with FCC emissions regulations can be used. Horns, prime focus and offset parabolic dishes, and planar slot arrays are all included.

Transmit power may be generated with a Gunn diode source, an injection-locked amplifier or a MMW tube source resonating at the chosen carrier frequency or at any sub-harmonic of that frequency. Source power can be amplitude, frequency or phase modulated using a diode switch, a mixer or a biphase or continuous phase modulator. Modulation can take the form of simple bi-state AM modulation, or can involve more than two symbol states; e.g. using quantized amplitude modulation (QAM). Double-sideband (DSB), single-sideband (SSB) or vestigial sideband (VSB) techniques can be used to pass, suppress or reduce one AM sideband and thereby affect bandwidth efficiency. Phase or frequency modulation schemes can also be used, including simple FM, bi-phase, or quadrature phase-shift keying (QPSK). Transmission with a full or suppressed carrier can be used. Digital source modulation can be performed at any date rate in bits per second up to eight times the modulation bandwidth in Hertz, using suitable symbol transmission schemes. Analog modulation can also be performed. A monolithic or discrete-component power amplifier can be incorporated after the modulator to boost the output power. Linear or circular polarization can be used in any combination with carrier frequencies to provide polarization and frequency diversity between transmitter and receiver channels. A pair of dishes can be used instead of a single dish to provide spatial diversity in a single transceiver as well.

The MMW Gunn diode and millimeter-wave amplifier can be made on indium phosphide, gallium arsenide, or metamorphic InP-on-GaAs. The millimeter-wave amplifier can be eliminated completely for short-range links. The detector can be made using silicon or gallium arsenide. The mixer/downconverter can be made on a monolithic integrated circuit or fabricated from discrete mixer diodes on doped silicon, gallium arsenide, or indium phosphide. The phase lock loop can use a microprocessor-controlled quadrature (I/Q) comparator or a scanning filter. The detector can be fabricated on silicon or gallium arsenide, or can comprise a heterostructure diode using indium antimonide.

The backup transceivers can use alternate bands 5.9-6.9 GHz, 17.7-19.7 GHz, or 21.2-23.6 GHz; all of which are covered under FCC Part 101 licensing regulations. In network use, a router or switch will typically partition a data stream to use both the millimeter wave link and the microwave link simultaneously. During severe weather, the millimeter wave link will cease to deliver data and the router or switch will automatically send all data through the microwave back up link until such time as the weather clears and the millimeter wave link automatically resumes operation. The antennas can be Cassegrainian, offset or prime focus dishes, or flat panel slot array antennas, of any size appropriate to achieve suitable gain.

While the above description contains many specifications, the reader should not construe these as a limitation on the scope of the invention, but merely as exemplifications of preferred embodiments thereof. For example, the fully allocated millimeter-wave band referred to in the description of the preferred embodiment described in detail above along with state of the art modulation schemes may permit transmittal of data at rates exceeding 10 Gbits per second. Such data rates would permit links compatible with 10-Gigabit Ethernet, a standard that is expected to become practical within the next two years. The present invention is especially useful in those locations where fiber optics communication is not available and the distances between communications sites are less than about 15 miles but longer than the distances that could be reasonably served with free space laser communication devices. Ranges of about 1 mile to about 10 miles are ideal for the application of the present invention. However, in regions with mostly clear weather the system could provide good service to distances of 20 miles or more. Accordingly the reader is requested to determine the scope of the invention by the appended claims and their legal equivalents, and not by the examples given above.

What is claimed is:

1. A millimeter wave communications system comprising:
A) a first millimeter wave transceiver system located at a first site capable of transmitting and receiving to and from a second site through atmosphere digital information at frequencies greater than 70 MHz and at data rates of about 1.25 Gbps or greater, said first transceiver comprising:
1) at least one antenna producing a beam having a half-power beam width of about 2 degrees or less, and
2) a modulator for high data rate communication at high frequencies comprising:
a) resonant LC circuit comprising:
(1) a capacitor,
(2) an inductor,
(3) a diode
(4) a biasing means for back-biasing said diode to minimize transmission and forward biasing said diode to transmit;
B) a second millimeter wave transceiver system located at a second site capable of transmitting and receiving to and from a second site through atmosphere digital information at frequencies greater than 70 MHz and at data rates of about 1.25 Gbps or greater, said second transceiver comprising:
1) at least one antenna producing a beam having a half-power beam width of about 2 degrees or less, and
2) a modulator for high data rate communication at high frequencies comprising:
a) resonant LC circuit comprising:
(1) a capacitor,
(2) an inductor,
(3) a diode
(4) a biasing means for back-biasing said diode to minimize transmission and forward biasing said diode to transmit.

2. A system as in claim 1 wherein said first transceiver system is configured to transmit and receive information at frequencies greater than 70 GHz.

3. A system as in claim 1 wherein said first transceiver system is configured to transmit and receive information at frequencies greater than 90 GHz.

4. A system as in claim 1 wherein said first transceiver system is configured to transmit and receive information at frequencies between 71 and 76 GHz.

5. A system as in claim 1 wherein said first transceiver system is configured to transmit and receive information at frequencies between 92 and 95 GHz.

6. A system as in claim 1 wherein one of said first and second transceiver systems is configured to transmit at frequencies in the range of about 71.8+/−0.63 GHz and to receive information at frequencies in the range of about 73.8+/−0.63 GHz.

7. A system as in claim 1 wherein one of said first and second transceiver systems is configured to transmit at frequencies in the range of about 92.3 to 93.2 GHz and to receive information at frequencies in the range of about 94.1 to 95.0 GHz.

8. A system as in claim 1 and further comprising a back-up transceiver system and configured to provide continue transmittal of information between said first and second sites in the event of abnormal weather conditions.

9. A system as in claim 7 wherein said backup transceiver system is a microwave system.

10. A system as in claim 7 wherein said backup transceiver system is configured to operate in the frequency range of less than 11.7 GHz.

11. A system as in claim 1 wherein said first and said second sites are separated by at least one mile.

12. A system as in claim 1 wherein said first and said second sites are separated by at least 2 miles.

13. A system as in claim 1 wherein said first and said second sites are separated by at least 7 miles.

14. A system as in claim 1 wherein said first and said second sites are separated by at least 10 miles.

15. A system as in claim 1 wherein each of said first and said second transceiver are configured to transmit and receive information at bit error ratios of less than 10⁻¹⁰ during normal weather conditions.

16. A system as in claim 1 wherein both said first and said second transceiver systems are equipped with antennas providing a gain of greater than 50 dB.

17. A system as in claim 15 wherein at least one of said antennas is a flat panel antenna.

18. A system as in claim 15 wherein at least one of said antennas is a Cassegrain antenna.

19. A system as in claim 15 wherein at least one of said antennas is a flat panel antenna.

20. A system as in claim 1 wherein each of said first and said second transceiver are configured to transmit and receive information at bit error ratios of less than 10⁻¹⁰ during normal weather conditions.

21. A system as in claim 1 wherein each of said first and second transceivers comprise two antennas, a transmit antenna and a receive antenna.

22. A system as in claim 1 wherein each of said first and second transceivers comprise only one antenna configured to transmit and to receive.

23. A modulator for high data rate communication at high frequencies comprising a resonant LC circuit comprising:
(1) a capacitor,
(2) an inductor,
(3) a diode
(4) a biasing means for back-biasing said diode to minimize transmission and forward biasing said diode to transmit.
